(19) United States
(12) Patent Application Publication
(10) Pub. No.: US 2008/0190977 A1
(43) Pub. Date: Aug. 14, 2008

(54) Vehicle gate with interchangeable accessories

(75) Inventor: Larry Douglas Estabrook, Ft. Pierce, FL (US)

Correspondence Address: LARRY D. ESTABROOK, 7507 LAKESIDE WAY, FT. PIERCE, FL, 34951, US

(73) Assignee: Larry Douglas Estabrook, Ft. Pierce, FL (US)

(21) Appl. No.: 12/068,766

(22) Filed: Feb. 11, 2008

Related U.S. Application Data
(60) Provisional application No. 60/889,265, filed on Feb. 10, 2007.

(51) Int. Cl. B60R 9/00; B62D 25/00

(52) U.S. Cl. 224/404; 296/37.6; 296/51; 224/535

(57) ABSTRACT

Gates on motorized and non-motorized vehicles such as the tailgate of a truck have started to be used for the attachment of accessories. The accessories on the market often attach directly to the existing gate and may take up significant room from the vehicle cargo space. The accessory may have to be removed from the gate prior to transport. Most often the accessory is used with the gate dropped in the traditional manner. This invention allows for a gate design into which a variety of accessories such as a barbecue, toolbox, storage units, fold-out ladders, bed extension, and a variety of other accessories can easily be interchanged. The gate and accessory may be configured so that it can be used in several different positions including the traditionally open gate position and a position where the gate assumes a swung out table top position.

### REFERENCE TO RELATED APPLICATION

This application claims the benefit of U.S. Provisional Patent Application Ser. No. 60/889,265 filed Feb. 10, 2007.

### BACKGROUND OF INVENTION

The present invention relates to gates such as those used on trucks and other vehicles, or on motorized and non-motorized transports such as trailers. This invention relates to gates configured to carry such objects as a barbeque, toolbox, storage box, fold-out ladder, tabletop, bed extension and other appliances and accessories, and more particularly, can use the dead space in the gate to create an inset into which interchangeable accessories affix during transport and use. An additional field of the invention is the ability for said gate to move and create a level working area, access to the accessory or complete access to the rest of the vehicle.

In recent years there has been an increased interest in using the gate of a vehicle to support accessories. The products on the market require the accessory to be bolted onto the gate. Bed space is taken away by the accessory when the gate is closed as shown in U.S. Pat. No. 5,730,344. In other cases the attachment must be removed from the gate prior to transportation as shown in U.S. Pat. No. 5,857,741. In still other cases containers are attached directly to a truck bed taking space away from the load capacity of the bed as in U.S. Pat. No. 4,518,189. Once attached the bolted accessory is often left in place. Access to the remainder of the vehicle bed is blocked by the attached accessory. Vehicles frequently take on a focused use such as work, family or fun.

Therefore there is a need for a way to attach interchangeable accessories which take up less bed space and may be moved out of the way for access to the bed or to increase working area. This invention addresses those needs and no patents or articles that take this approach, were found in the search.

### SUMMARY OF INVENTION

It is an object of the current invention, among others, to design a gate, such as those used on trucks or other vehicles, in which there is an inset or depression. An insert is then put into the inset and affixed to the inset. The method of affixing the insert allows for the insert to be removed. The base of an accessory is able to affix to the inset. Accessories include barbeques, toolboxes, storage compartments, folding ladders, tabletop, bed extension and the like. In most cases, the gate is able to open and close with the accessory in place. The accessories can also be placed in a free standing stand to allow for storage or use when not attached to the inset.

One object of the present invention is to allow for the gate and accessory assembly to operate in various positions. To accommodate this, the insert can be affixed to the inset in two opposing directions. A multi-directional mechanism such as a ball and socket joint is affixed to the lower corner of the gate to allow the gate freedom of movement. The gate can be opened in various ways such as the conventional manner, swung out or swung out and down resulting in a plane similar to a table top. Supports such as telescoping table legs are affixed to the corners of the gate and used to add stability.

Placing the gate in alternative positions allows access to the rest of the vehicle. Additionally, the interchangeable nature of the accessories will increase the versatility of the vehicle. One could for example, attach a toolbox accessory during the week and then a barbecue for an outing on the weekend.

### BRIEF DESCRIPTION OF PICTURES

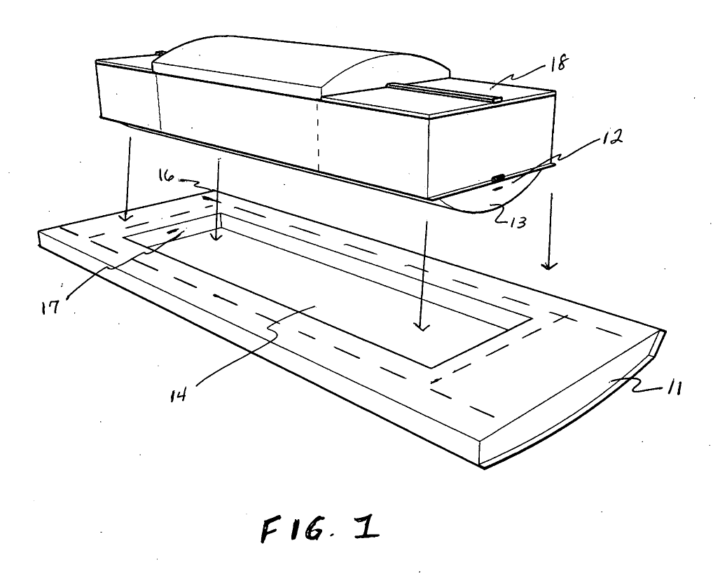

FIG. 1 shows the inset in the gate and an accessory, barbecue, designed with an insert.

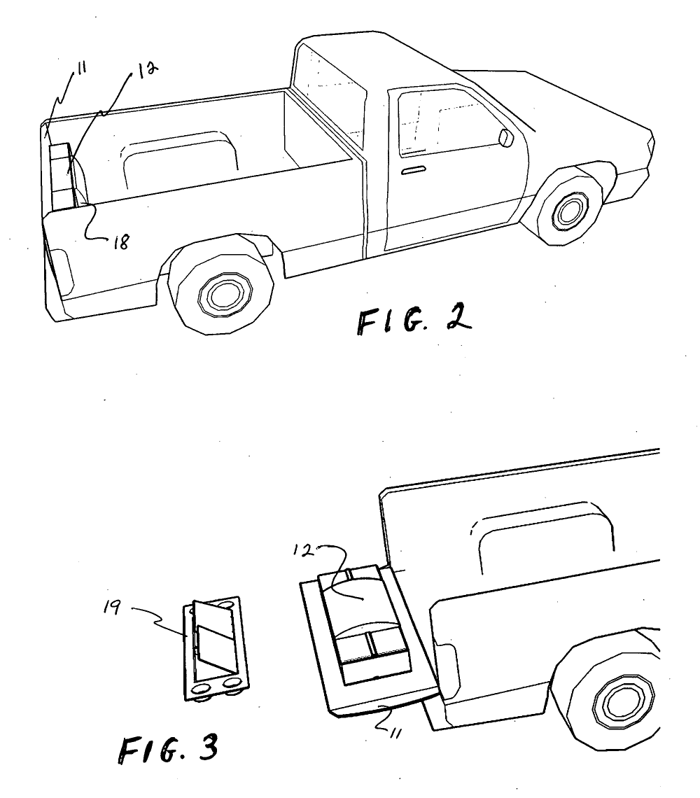

FIG. 2 shows a tailgate in the closed position with an accessory attached.

FIG. 3 shows a tailgate in the traditionally opened position with the barbecue accessory attached. An alternative accessory, cup holders and storage compartments is also shown.

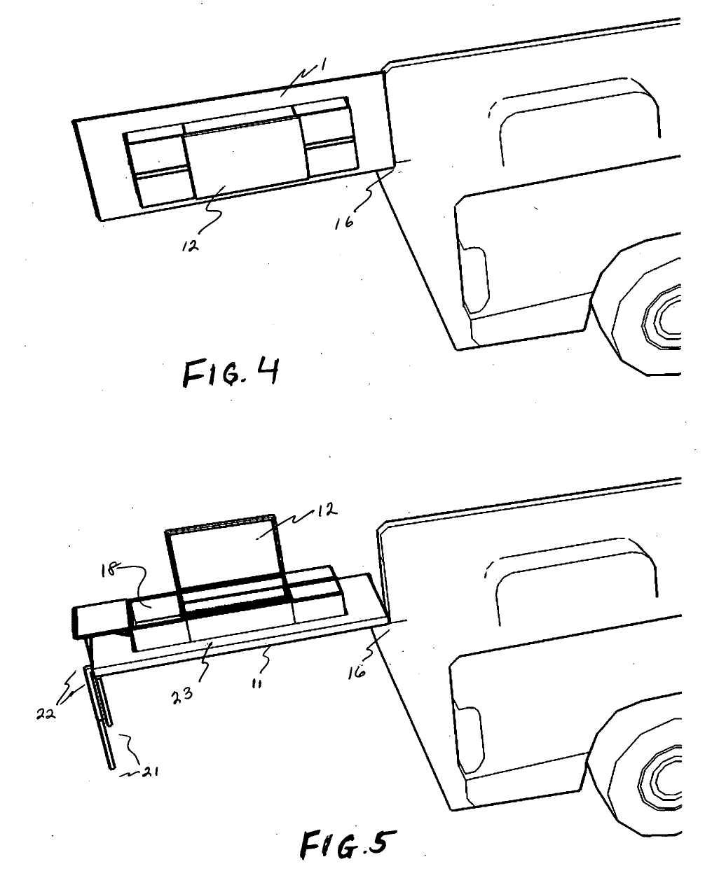

FIG. 4 shows the tailgate with the barbecue accessory attached swung out of the way of the truck bed.

FIG. 5 shows the tailgate and the barbecue accessory in a fully open position. The barbecue in this figure has been mounted in the opposite direction as the one in FIG. 2.

### DETAILED DESCRIPTION

These drawings are used for understanding the invention. A barbecue and cup holder accessories are for illustration. It will be understood that no limitation of the scope of the invention is thereby intended, with such alterations and further modifications in the illustrated device and such further applications of the principles of the inventions as illustrated therein being contemplated as would normally occur to one skilled in the area to which the invention relates.

The combination of the invented gate 11 and interchangeable accessories 12 designed with an insert 13 that locks into the gate and provides for an unlimited number of possible uses for a vehicle. In FIG. 1 the gate is made with an inset 14 that is reinforced with, in this case, an internal metal frame 15. The frame adds structure for the pivoting mechanism 16 and to allow heavy accessories 12 to be attached by a mechanism such as a simple arm attached to the gate that rotates into a slit in the inset 17. Storage compartments 18 in the barbecue attachment may be used to house items while the gate is in this position.

FIG. 2 depicts the gate 11, with the barbecue accessory 12, attached in the closed position. The compartments of the barbecue 18 can be used for storage.

FIG. 3 shows the gate 11, in the traditionally open position. The barbecue accessory 12 is attached and able to be used in this position. An interchangeable accessory, a cup holder and storage unit 19 can replace the barbecue 12 on the gate 11.

FIG. 4 shows the gate 11 and barbecue accessory 12 in the swung out position. The pivoting mechanism, such as a ball and socket 16 allows the gate to open in this position and in the position of FIG. 5, the fully opened position. In the fully opened position the barbecue accessory is mounted in the opposite direction as when it was mounted for use in the FIG. 3 position. As in FIG. 3 the barbecue accessory 12 and the accessory's storage compartments 18 are fully accessible while the gate makes a table top 11 for working. Telescoping table legs 21 collapse, pivot at point 22 and slide into the framework of the gate 23.

What is claimed is:

1. A gate design that accepts interchangeable inserts to be used on the back or side of a vehicle or motorized or non-motorized transport such as a trailer and consisting primarily of;
(a) an inset in the gate
(b) a means to affix an accessory such as barbeque, toolbox, storage box, fold-out ladder, tabletop and other appliances and accessories to the inset
(c) fabricated, blow molded, or such using metals or synthetics or a combination.

2. The inset as claimed in claim 1
(a) uses the space traditionally between the outer and inner skins of a fabricated gate when there is such a space,
(b) is substantially rectangular in shape
(c) is reinforced to allow for heavy inserts
(d) is fabricated, blow molded or such using metals or synthetics or a combination.

3. The means to affix the insert into the inset as claimed in claim 1;
(a) enables the insert to be mounted and removed such as lock pins or pre-threaded nuts in the frame with bolts and wing nuts,
(b) enables the insert to remain affixed to the gate while in use
(c) allows for the gate to be closed while the accessory is in place but is not required to.

4. The means to affix the insert as claimed in claim 3 includes a locking device such as a key lock, finger print pad or other device meant to protect the accessory from theft or vandalism.

5. The accessory mounted as claimed in claim 1 allows for the use of a truck bed cover such as a Tonneau cover at the same time.

6. The gate has multi-planar movement.

7. A device affixed to the bottom corner of a gate and vehicle allows the gate to be lowered in the conventional manner, swung out remaining vertical to the ground, and both swung out and rotated flat so that the gate itself in parallel to the ground, or any combination thereof as claimed in claim 6.

8. A supporting device such as two or three legs are used to support the open gate claimed in claim 7.
